(19) United States
(12) Patent Application Publication
(10) Pub. No.: US 2022/0043616 A1
(43) Pub. Date: Feb. 10, 2022

(54) Job Management Program

(71) Applicant: KYOCERA Document Solutions Inc., Osaka-shi (JP)

(72) Inventors: Takanori MIYAMOTO, Osaka-shi (JP); Kazuki Dozen, Osaka-shi (JP)

(21) Appl. No.: 17/387,070

(22) Filed: Jul. 28, 2021

(30) Foreign Application Priority Data
Aug. 4, 2020 (JP) 2020-132441

(51) Int. Cl. G06F 3/12

(52) U.S. Cl. CPC G06F 3/1258; G06F 3/1286; G06F 3/1208

(57) ABSTRACT

When a job management program is executed by an arithmetic processing device in a terminal device, the arithmetic processing device operates as a job management unit for inputting a print job to an image forming apparatus. When a predetermined command is designated by a user operation, a job management unit inputs an image quality control print job for printing a specific color patch chart image on a target medium without applying color correction based on a color profile to the image forming apparatus for creating a color profile for the target medium desired by the user.

### INCORPORATION BY REFERENCE

This application is based upon and claims the benefit of priority from the corresponding Japanese Patent Application No. 2020-132441 filed on Aug. 4, 2020 the entire contents of which are incorporated herein by reference.

The present disclosure relates to a job management program.

### BACKGROUND

In one color profile creation system, a personal computer (a) causes an inkjet printer to print a chart, (b) causes a colorimeter to perform colorimetry of the printed chart, (c) creates a color table based on the colorimetry result, and (d) creates a color profile by associating the color table with paper, according to a user operation.

However, when a chart for colorimetry is printed on a target medium with a printer, so that the chart be printed under a specific condition and the colorimetric result be compared with a standard value, it is necessary to set the specific condition before the chart is printed, which is troublesome for a user.

### SUMMARY

A job management program according to the present disclosure is a job management program for operating a computer as a job management unit for inputting a print job to an image forming apparatus, and when a predetermined command is specified by a user operation, the job management unit inputs an image quality control print job for printing a specific color patch chart image on a target medium without applying color correction based on a color profile to the image forming apparatus for creating a color profile for the target medium desired by the user.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image forming system in which a job management program according to an embodiment of the present disclosure is used.

FIG. 2 is a block diagram showing the configuration of the terminal device 1 in FIG. 1.

FIG. 3 is a block diagram showing the configuration of the image forming apparatus 3 in FIG. 1.

FIG. 4 shows an example of an operation screen displayed by the job management unit 31 in FIG. 1 (1/3).

FIG. 5 shows an example of an operation screen displayed by the job management unit 31 in FIG. 1 (2/3).

FIG. 6 shows an example of an operation screen displayed by the job management unit 31 in FIG. 1 (3/3).

### DETAILED DESCRIPTION

Embodiments of the present disclosure will be described below with reference to the drawings. It should be noted that the embodiments described below are merely illustrative of the present disclosure and are not intended to limit the technical scope of the present disclosure.

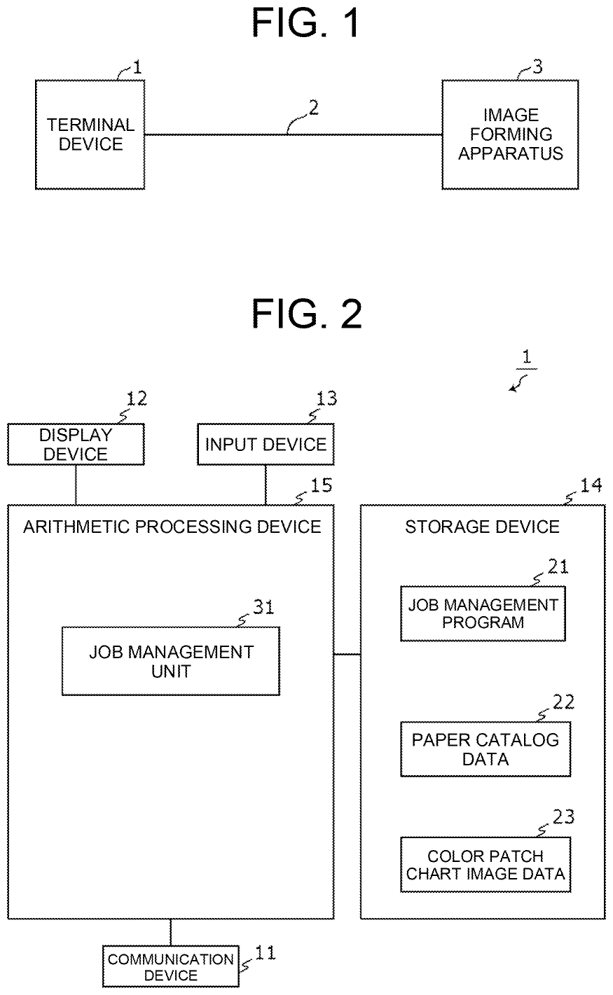

FIG. 1 is a block diagram showing a configuration of an image forming system in which a job management program according to an embodiment of the present disclosure is used. In the system shown in FIG. 1, a terminal device 1 is connected to a communication path 2 such as a computer network, and an image forming apparatus 3 is connected to the communication path 2. The terminal device 1 is a personal computer or the like on which the job management program according to the embodiment of the present disclosure is installed. The communication path 2 is a wireless or wired communication path using a wireless or wired computer network such as an in-house LAN (Local Area Network) or a peripheral device interface. Although the image forming apparatus 3 is a multi-function peripheral, it may be another apparatus having a printing function such as a printer.

Here, the configurations of the terminal device 1 and the image forming apparatus 3 will be described.

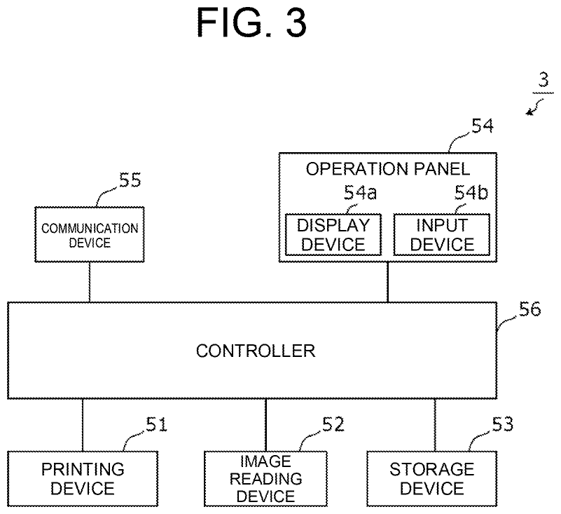

FIG. 2 is a block diagram showing the configuration of the terminal device 1 in FIG. 1. The terminal device 1 is, for example, a personal computer having a communication function in which an operating system, a utility program, and the like are installed. The terminal device 1 comprises a communication device 11, a display device 12, an input device 13, a storage device 14, and an arithmetic processing device 15.

The communication device 11 is connected to the communication path 2 and performs data communication with other devices (such as the image forming apparatus 3) via the communication path 2 using a predetermined communication protocol. As the communication device 11, a network interface, a peripheral device interface or the like is used. The display device 12 is a device such as a liquid crystal display that displays various screens to the user of the terminal device 1. The input device 13 is a device such as a keyboard, a mouse, a touch panel, or a hard key for detecting a user operation by the user.

The storage device 14 is a device capable of storing various data and programs. As the storage device 14, a nonvolatile mass storage medium such as a nonvolatile memory or a hard disk drive is used. The storage device 14 stores an installed job management program 21, paper catalog data 22, color patch chart image data 23, and the like.

The arithmetic processing device 15 is a computer having a CPU (Central Processing Unit), ROM (Read Only Memory), a RAM (Random Access Memory), or the like, and loads a program from the storage device 14, a ROM, or the like into a RAM, and executes the program by a CPU, thereby realizing various processing units.

After the activation of the terminal device 1, various programs are appropriately executed by the arithmetic processing device 15. In this embodiment, by executing the job management program 21, the arithmetic processing device 15 operates as the job management unit 31 that inputs print jobs to the image forming apparatus 3. In this embodiment, a job management unit 31 sequentially inputs the print jobs registered in a job folder (hot folder). In addition to inputting print jobs, the job management unit 31 acquires status information of the image forming apparatus 3 and predicts the color material consumption and printing cost for each job.

FIG. 3 is a block diagram showing the configuration of the image forming apparatus 3 in FIG. 1. As shown in FIG. 3, the image forming apparatus 3 includes a printing device 51, an image reading device 52, a storage device 53, an operation panel 54, a communication device 55, and a controller 56.

The printing device 51 is an internal apparatus for printing an image designated by a print job on a medium one page at a time by a predetermined printing method (for example, an inkjet method or an electrophotographic method).

The image reading device 52 is an internal device that reads a document image from a document and generates image data thereof.

The storage device 53 is a nonvolatile storage device such as a flash memory. The operation panel 54 is disposed on the housing surface of the image forming apparatus 3 and has a display device 54a for displaying various information to a user and an input device 54b for receiving a user operation. As the display device 54a, for example, a liquid crystal display is used. As the input device 54b, a hard key, a touch panel or the like is used. The communication device 55 is a circuit that is connected to the communication path 2 and performs data communication with other devices (such as the terminal device 1) connected to the communication path 2. As the communication device 55, for example, a network interface or a peripheral device interface is used.

The controller 56 is provided with a processor for executing a predetermined program, an ASIC (Application Specific Integrated Circuit) or the like, receives a print job by using the communication device 55, receives a job based on a user operation to the operation panel 54, executes predetermined image processing (color correction, color conversion, halftoning, etc.) as necessary, controls the printing device 51, the image reading device 52 or the like, and executes the received job.

Returning to FIG. 1, the job management unit 31 in the terminal device 1 inputs an image quality control print job to the image forming apparatus 3 when a predetermined command is specified by a user operation on the input device 13. The image quality control print job causes a specific color patch chart image based on a predetermined color patch chart image data 23 to be printed on a target media desired by the user without applying color correction based on any color profile for creating a color profile for the target media. A color patch chart image includes a plurality of color patches that differ from each other in at least one of brightness, saturation, and hue.

Further, in this embodiment, the job management unit 31 (a) specifies the paper catalog selected by the user from the paper catalog list in the paper catalog data 22 as the target media, and (b) includes, in the paper catalog of the target media, the color profile based on the colorimetry result of the color patch chart image printed on the target media, and stores the result in the storage device 14.

The color measurement result is obtained by reading the color patch chart image by the image reading device 52 of the image forming apparatus 3, and is acquired by the job management unit 31 via the communication path 2. That is, when a user sets a target medium on which a color patch chart image is printed in the image reading device 52 and the user operates the image forming apparatus 3, the image of the target medium is read by the image reading device 52. Alternatively, a line sensor may be provided in a transport path in the downstream side of the printing device 51, image reading of a target medium on which a color patch chart image is printed may be executed by the line sensor, and the read image may be transmitted as a colorimetric result to the job management unit 31 via the communication path 2. Alternatively, the colorimetry result may be obtained by a colorimeter and input to the terminal device 1 (job management unit 31).

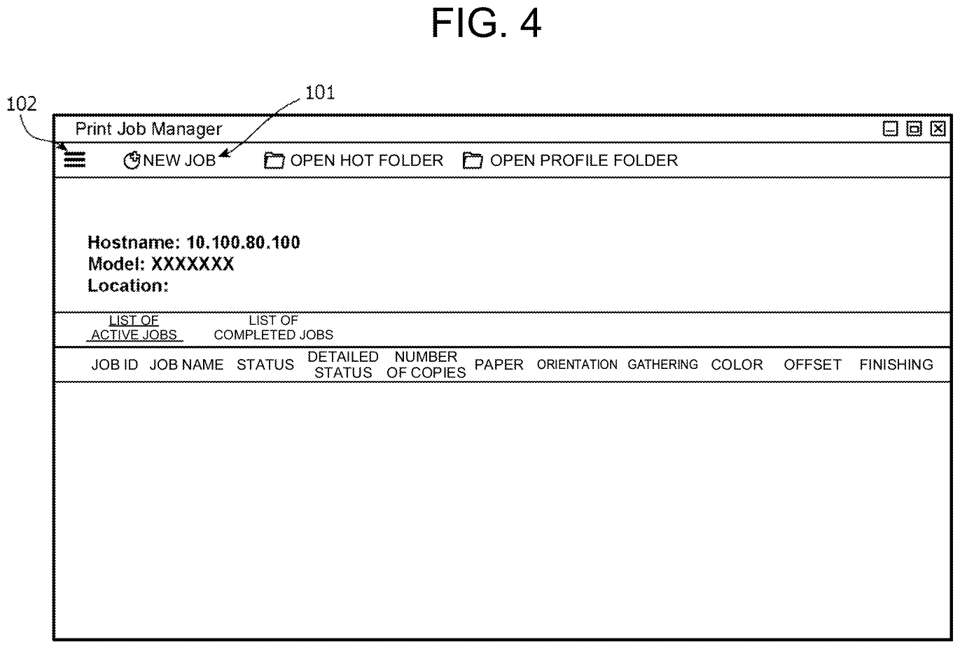

FIGS. 4 to 6 are views showing examples of operation screens displayed by the job management unit 31 in FIG. 1.

In this embodiment, when the job management program 21 is executed, the job management unit 31 is activated to display an operation screen as shown in FIG. 4 as one window on the display device 12. On the operation screen shown in FIG. 4, a list of currently running or waiting jobs and a list of completed jobs for a specific image forming apparatus 3 are displayed, and a soft key 101 operated when a new job is input and a menu key 102 as a soft key are displayed.

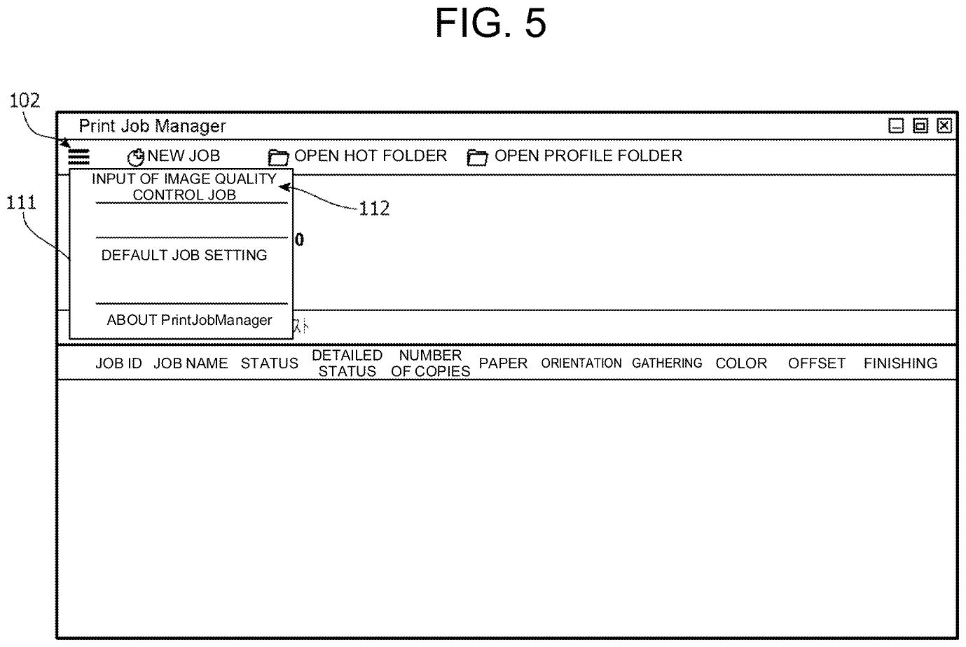

When the pressing of the menu key 102 is detected by the input device 13, the job management unit 31 superimposes a command menu 111 on the operation screen and displays it on the image forming apparatus 3, as shown in FIG. 5, for example.

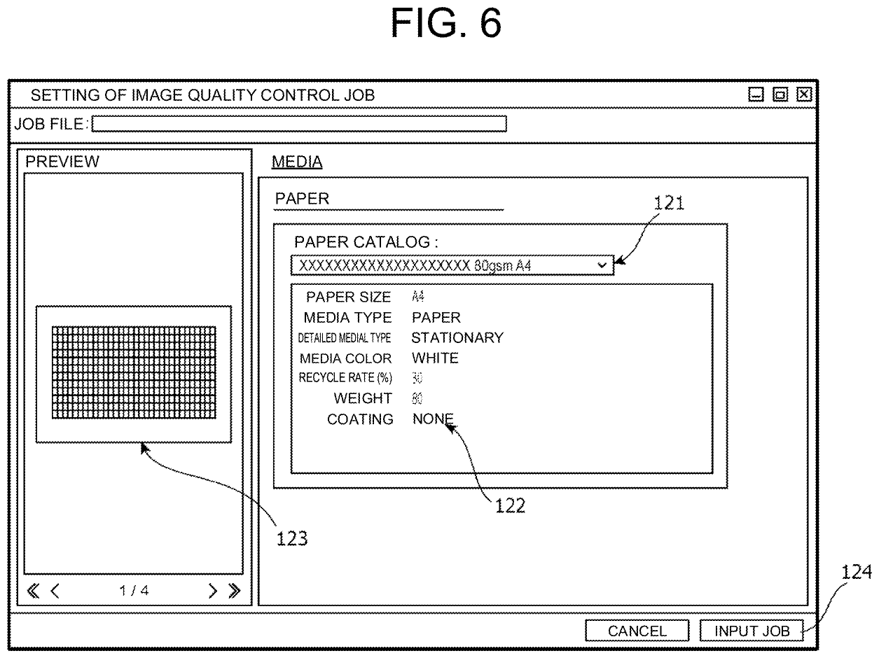

Further, when the input device 13 detects an operation for selecting an item “input image quality control job” 112 from the command menu 111, the job management unit 31 causes the image forming apparatus 3 to display a setting screen of the image quality control job as an operation screen, as shown in FIG. 6, for example.

On this setting screen, the job management unit 31 displays an above-described paper catalog list pull-down menu 121, and selectively displays the paper catalog as shown in FIG. 6, for example, from the paper catalog list shown by the pull-down menu 121 in accordance with a user operation on the input device 13. In the setting screen, the job management unit 31 displays, on the display device 12, the preview image 123 of the target medium on which the color patch chart image is printed together with a set value 122 in the paper catalog selected by the user in this manner.

At this time, in this setting screen, the job management unit 31 (a) displays a soft key 124 together with the set value 122 and a preview image 123 on the display device 12, and (b) when the pressing of the soft key 124 is detected by the input device 13, determines that the predetermined command has been designated, and immediately inputs the image quality control print job to the image forming apparatus 3.

In this embodiment, as described above, after the color profile of a certain medium (such as paper) is registered in the paper catalog for that medium, the job management unit 31 (a) specifies the paper catalog selected by the user from the above-described paper catalog list, and (b) inputs a print job to the image forming apparatus 3 for printing the user image by applying color correction based on the color profile included in the specified paper catalog, for printing the user image (i.e. printing the image selected by the user).

Next, the operation of the job management unit 31 in the terminal device 1 will be described.

When a predetermined user operation is detected by the input device 13, the job management program 21 is executed and the job management unit 31 is activated.

The job management unit 31 displays an operation screen as shown in FIG. 4, for example, on the display device 12. When the above-described user operation is detected, a screen for setting an image quality control job as shown in FIG. 6 is displayed. When the user selects a paper catalog of a desired medium on the setting screen, the set value 122 of the paper catalog and the preview image 123 of the paper catalog are displayed. After confirming the set value 122 of the paper catalog and the preview image 123, the user presses the soft key 124 to cause the job management unit 31 to execute the image quality control job.

When the input device 13 detects the operation, the job management unit 31 first specifies the selected paper catalog, transmits a job request of the image quality control job specifying the paper catalog and the color patch chart image to the image forming apparatus 3, and inputs the image quality control job.

Upon receiving the job request, the controller 56 of the image forming apparatus 3 causes the printing device 51 to print the color patch chart image on the media of the paper catalog without performing color correction.

Then, the user performs colorimetry (image reading by the image reading device 52 or the like) of the medium on which the color patch chart image is printed, and upon acquiring the colorimetry result, the job management unit 31 generates a color profile by an existing method based on the colorimetry result, and stores the color profile in the storage device 14 in association with the paper catalog of the medium.

Thereafter, when the user causes the image forming apparatus 3 to print his/her desired user image (such as a document image), the user performs a user operation for selecting a paper catalog, and the job management unit 31 selects a paper catalog, specifies a color profile associated with the selected paper catalog, specifies the paper catalog and the color profile, transmits a job request for a print job for printing the user image to the image forming apparatus 3, and inputs the print job.

Upon receiving the job request, the controller 56 of the image forming apparatus 3 executes color correction based on the color profile, and causes the printing device 51 to print the user image on the media of the paper catalog.

As described above, according to the embodiment, when the job management program 21 is executed by the arithmetic processing device 15 in the terminal device 1, the arithmetic processing device 15 operates as the job management unit 31 for inputting the print job to the image forming apparatus 3. When a predetermined command is specified by a user operation, the job management unit 31 inputs an image quality control print job for printing a specific color patch chart image on a target medium without applying color correction based on the color profile to the image forming apparatus 3 in order to create a color profile for the target medium desired by the user.

Thus, the user can print the color patch chart for colorimetry and generate a color profile for the medium, with a simple operation.

Various changes and modifications to the foregoing embodiments will be apparent to those skilled in the art. Such changes and modifications may be made without departing from the spirit and scope of the subject matter and without diminishing the intended benefits. That is, such changes and modifications are intended to be included in the claims.

For example, in the above-described embodiment, the job management program 21 may be recorded on a portable computer-readable recording medium and installed in the terminal device 1 from the recording medium.

The present disclosure is applicable to, for example, a program for inputting a job to an image forming apparatus.

What is claimed is:

1. A job management program for causing a computer to operate as a job management unit for inputting a print job to an image forming apparatus,
when a predetermined command is specified by a user operation, the job management unit inputs an image quality control print job for printing a specific color patch chart image on a target medium without applying color correction based on a color profile to the image forming apparatus for creating a color profile for the target medium desired by the user.

2. The job management program according to claim 1, wherein
the job management unit (a) specifies a paper catalog selected by the user from a paper catalog list as the target media, and (b) includes a color profile based on the colorimetry result of the color patch chart image printed on the target media in the paper catalog of the target media.

3. The job management program according to claim 2, wherein
in order to print a user image, the job management unit (a) specifies the paper catalog selected by the user from the paper catalog list, and (b) inputs to the image forming apparatus a print job for printing the user image by applying color correction based on the color profile included in the specified paper catalog.

4. The job management program according to claim 2, wherein
the job management unit causes a display device to display a preview image of the target medium on which the color patch chart image is printed together with the set value in the paper catalog selected by the user.

5. The job management program according to claim 4, wherein
the job management unit (a) displays a predetermined operation screen including the set value, the preview image, and the soft key on the display device, and (b) when a press of a soft key is detected by the input device, determines that the predetermined command is designated and immediately inputs the image quality control print job to the image forming apparatus.
